(19) United States
(12) Patent Application Publication
(10) Pub. No.: US 2026/0352815 A1
(43) Pub. Date: Nov. 5, 2026

(54) VIDEO DECODING APPARATUS, VIDEO CODING APPARATUS

(71) Applicant: SHARP KABUSHIKI KAISHA, Sakai City, Osaka (JP)

(72) Inventors: YUKINOBU YASUGI, Sakai City, Osaka (JP); Zheming FAN, Sakai City, Osaka (JP); TOMOHIRO IKAI, Sakai City, Osaka (JP); TOMOKO AONO, Sakai City, Osaka (JP)

(21) Appl. No.: 19/157,141

(22) PCT Filed: Jun. 3, 2024
(86) PCT No.: PCT/JP2024/020221

§ 371 Date: Aug. 15, 2025

Related U.S. Application Data
(60) Provisional application No. 63/540,997, filed on Sep. 28, 2023.

(51) Int. Cl. H04N 19/11; H04N 19/105; H04N 19/593

(52) U.S. Cl. CPC H04N 19/11; H04N 19/105; H04N 19/593

(57) ABSTRACT

This invention aims to enhance precision by improving the generation method of the existing GradMPMList. New modes (dimdMode2×2, dimdMode4×4, dimdModeTop, dimdModeLeft) are appended to the existing GradMPMList to create a new GradMPMList. The GradMPMList is used in the intra prediction modes in the codec and has an impact on angular modes, TIMD, SGPM, and TMRL intra prediction methods.

### TECHNICAL FIELD

The embodiments of the present invention relate to, a video decoding apparatus, a video coding apparatus.

### BACKGROUND ART

A video coding apparatus which generates coded data by coding a video, and a video decoding apparatus which generates decoded images by decoding the coded data are used for efficient transmission or recording of videos.

For example, specific video coding schemes include H.264/AVC, High-Efficiency Video Coding (HEVC), and Versatile Video Coding (VVC) schemes, and the like.

In such a video coding scheme, images (pictures) constituting a video are managed in a hierarchical structure including slices obtained by splitting an image, coding tree units (CTUs) obtained by splitting a slice, units of coding (coding units; which is referred to as CUs) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction error components (which may be referred to also as “difference images” or “residual images”) obtained by subtracting the prediction image from the input image are coded. Generation methods of prediction images include an inter-picture prediction (an inter-prediction) and an intra-picture prediction (intra prediction).

In recent video coding and decoding techniques, NPL1 introduced a method for generating a sorted MPM list. The generation of the MPM list is divided into two steps: first, deriving the possible prediction modes for the current block based on the neighboring blocks, and then generating the MPM list based on these prediction modes. NPL1 method adds a sorting operation between these two steps, allowing the extension modes with lower SATD cost to be filled into the MPM list first.

### CITATION LIST

### Non Patent Literature

NPL 1: Luhang Xua (Oppo), Chuan Zhou (Vivo), Hongtao Wang (Qualcomm), etc, “EE2-1.24: Combinations of MPM related tests,” JVET-AD0085, Antalya, T R, April 2023.

### SUMMARY OF INVENTION

In one example, a video decoding apparatus for generating a prediction image, the video decoding apparatus includes a DIMD prediction unit configured to derive plural of intra prediction mode using plural set of filter and reference region, and configure to derive a intra prediction image using plural intra prediction images derived by the derived intra prediction modes.

In one example, a video coding apparatus includes an MPM candidate generation unit configured to derive a MPM candidate list of intra prediction modes.

### Technical Problem

The MPMlist is used for intra prediction, and it is composed of prediction angulars from neighboring blocks of the current block, the extension of these angulars, and a default list, making a total of 22 elements. The MPM list is used in three instances during the encoding and decoding process: 1) The first two elements in the MPMlist may be directly added to the RDOlist. 2) The MPMlist is utilized for generating the bitstream, where the positions of the elements impact the length of the bitstream. 3) Elements from the MPMlist are employed in intra prediction methods such as TIMD, SGPM, and TMRL. NPL1 summarizes the results of the latest MPM generation method. This invention aims to improve the accuracy by modifying the method of generating the MPMlist through the addition of new elements.

### Solution to Problem

The aim of this invention is to improve prediction accuracy by modifying the generation method of the MPMlist. In this invention, two entirely new prediction angulars, dimdMode2×2 and dimdMode4×4, are added to the MPMlist, thereby modifying the composition of elements in the list. Additionally, the order of the existing elements in the MPMlist can also be changed, resulting in a newMPMlist.

### Advantageous Effects of Invention

According to an aspect of the present invention, the quality of the codecs can be improved without adding additional calculations.

### BRIEF DESCRIPTION OF DRAWINGS

FIG. 1 is a schematic diagram illustrating a configuration of an image transmission system according to the present embodiment.

FIG. 2 is a diagram showing the hierarchical structure of the coded stream data.

FIG. 3 is a schematic diagram showing the type of intra-prediction mode (mode number).

FIG. 4 is a schematic diagram of the video decoding apparatus.

FIG. 5 shows the structure of the intra prediction image generation unit.

FIG. 6 is a diagram showing the details of the gradMPMList Generation Unit.

FIG. 7 is a block diagram showing the structure of a video coding apparatus.

FIG. 8 shows examples of the reference region used for gradient derivation.

FIG. 9 is a diagram showing the details of the DIMD prediction unit.

### DESCRIPTION OF EMBODIMENTS

### First Embodiment

Hereinafter, embodiments of the present disclosure is described with reference to the drawings.

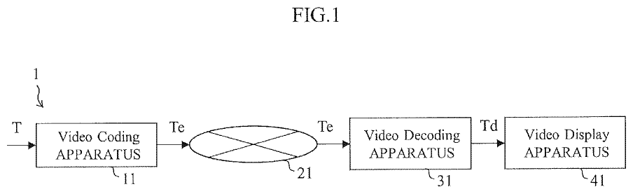

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and an image is displayed. The image transmission system 1 includes a video coding apparatus (image coding apparatus) 11, a network 21, a video decoding apparatus (image decoding apparatus) 31, and a video display apparatus (image display apparatus) 41.

An image T is input to the video coding apparatus 11.

The network 21 transmits a coding stream Te generated by the video coding apparatus 11 to the video decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting or the like. Furthermore, the network 21 may be substituted by a storage medium in which the coding stream Te is recorded, such as a Digital Versatile Disc (DVD: trademark) or a Blu-ray Disc (BD: trademark).

The video decoding apparatus 31 decodes each of the coding streams Te transmitted from the network 21 and generates one or multiple decoded images Td which are decoded.

The video display apparatus 41 displays all or part of the one or multiple decoded images Td generated by the video decoding apparatus 31. For example, the video display apparatus 41 includes a display device such as a liquid crystal display and an organic Electro-Luminescence (EL) display. Forms of the display include a stationary type, a mobile type, an HMD type, and the like. In addition, in a case that the video decoding apparatus 31 has a high processing capability, an image having high image quality is displayed, and in a case that the apparatus only has a lower processing capability, an image which does not require high processing capability and display capability is displayed.

### Operator

Operators and notations used in the present specification is described below. >> is an arithmetic right bit shift, << is an arithmetic left bit shift, & is a bitwise AND, I is a bitwise OR, \hat{ } is a bitwise XOR, I=is an OR assignment operator, and II indicates a logical sum.

x? y: z is a ternary operator to take y in a case that x is true (other than 0) and take z in a case that x is false (0).

Clip3 (x, y, z) is a function to clip z in a value equal to or greater than x and less than or equal to y, and a function to return x in a case that z is less than x (z<x), return y in a case that z is greater than y (z>y), and return z in other cases.

abs (a) is a function that returns the absolute value of a.

Int (a) is a function that returns the integer value of a.

floor (a) is a function that returns the maximum integer equal to or less than a.

ceil (a) is a function that returns the minimum integer equal to or greater than a.

a/d represents division of a by d (round down decimal places).

X=y . . . z represents x takes on integer values starting from y to z, inclusive, with x, y, and z being integer numbers and z being greater than or equal to y.

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 is described.

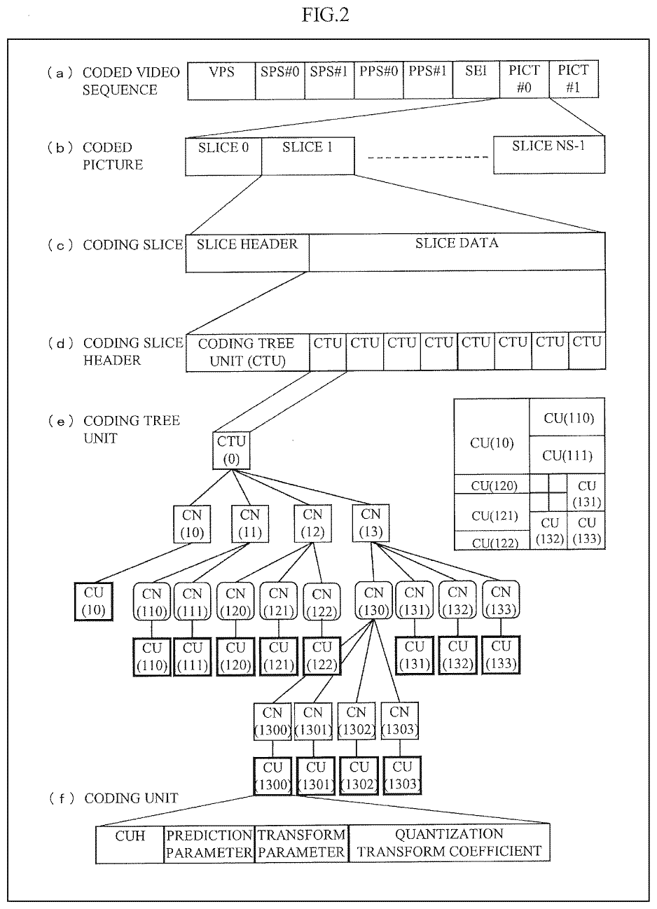

FIG. 2 is a diagram illustrating a hierarchical structure of data of the coding stream Te. The coding stream Te includes a sequence and multiple pictures constituting the sequence illustratively. (a) to (f) of FIG. 2 are diagrams illustrating a coded video sequence defining a sequence SEQ, a coded picture prescribing a picture PICT, a coding slice prescribing a slice S, a coding slice data prescribing slice data, a coding tree unit included in the coding slice data, and a coding unit (CU) included in each coding tree unit, respectively.

### Coded Video Sequence

In the coded video sequence (CVS, coding stream), a set of data referred to by the video decoding apparatus 31 to decode the coded sequence sequences to be processed is defined. As illustrated in FIG. 2, the CVS includes a Video Parameter Set (VPS), a Sequence Parameter Set (SPS), a Picture Parameter Set (PPS), a picture (PICT), and Supplemental Enhancement Information (SEI).

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the video decoding apparatus 31 to decode a target sequence is defined. For example, a width and a height of a picture are defined. Note that multiple SPSs may exist. In that case, any of multiple SPSs is selected from the PPS.

In the picture parameter set PPS, a set of coding parameters referred to by the video decoding apparatus 31 to decode each picture in a target sequence is defined. For example, a reference value (pic_init_qp_minus26) of a quantization step size used for decoding of a picture and a flag (weighted_pred_flag) indicatingan application of a weighted prediction are included. Note that multiple PPSs may exist. In that case, any of multiple PPSs is selected from each picture in a target sequence.

### Coded Picture

In the coded picture, a set of data referred to by the video decoding apparatus 31 to decode the picture PICT to be processed is defined. As illustrated in FIG. 2, the picture PICT includes a slice 0 to a slice NS-1 (NS is the total number of slices included in the picture PICT).

Note that in a case that it is not necessary to distinguish each of the slice 0 to the slice NS-1 below, subscripts of reference signs may be omitted. In addition, the same applies to other data with subscripts included in the coding stream Te which is described below.

### Coding Slice

In the coding slice, a set of data referred to by the video decoding apparatus 31 to decode the slice S to be processed is defined. As illustrated in FIG. 2, the slice includes a slice header and a slice data.

The slice header includes a coding parameter group referred to by the video decoding apparatus 31 to determine a decoding method for a target slice. Slice type specification information (slice_type) indicating a slice type is one example of a coding parameter included in the slice header.

Examples of slice types that may be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to a uni-prediction and a bi-prediction, and the prediction image may be generated by using a larger number of reference pictures. Hereinafter, in a case that a slice is referred to as the P or B slice, the slice indicates a slice that includes a block in which the inter prediction may be used.

Note that, the slice header may include a reference to the picture parameter set PPS (pic_parameter_set_id).

### Coding Slice Data

In the coding slice data, a set of data referred to by the video decoding apparatus 31 to decode the slice data to be processed is defined. The slice data include CTUs as illustrated in FIG. 2. The CTU is a block of a fixed size (for example, 64×64) constituting a slice.

### Coding Tree Unit

In FIG. 2, a set of data referred to by the video decoding apparatus 31 to decode the CTU to be processed is defined. The CTU is split into coding units CUs, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of a tree structure obtained by recursive quad tree splits are referred to as Coding Nodes. Intermediate nodes of a quad tree, a binary tree, and a ternary tree are coding nodes, and the CTU itself is also defined as the highest coding node.

### Coding Unit

As illustrated in FIG. 2, a set of data referred to by the video decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

There are cases that the prediction processing is performed in units of CU or performed in units of sub-CU obtained by further splitting the CU. In a case that the sizes of the CU and the sub-CU are equal to each other, the number of sub-CUs in the CU is one. In a case that the CU is larger in size than the sub-CU, the CU is split into sub-CUs. For example, in a case that the CU has a size of 8×8, and the sub-CU has a size of 4×4, the CU is split into four sub-CUs which include two horizontal splits and two vertical splits.

There are two types of predictions (prediction modes), which are an intra prediction and an inter prediction. The intra prediction refers to a prediction in an identical picture, and the inter prediction refers to prediction processing performed between different pictures (for example, between pictures of different display times).

Transform and quantization processing is performed in units of CU, but the quantization transform coefficient may be subjected to entropy coding in units of subblock such as 4×4.

### Prediction Parameter

A prediction image is derived by a prediction parameter accompanying a block. The prediction parameter includes prediction parameters of the intra prediction and the inter prediction.

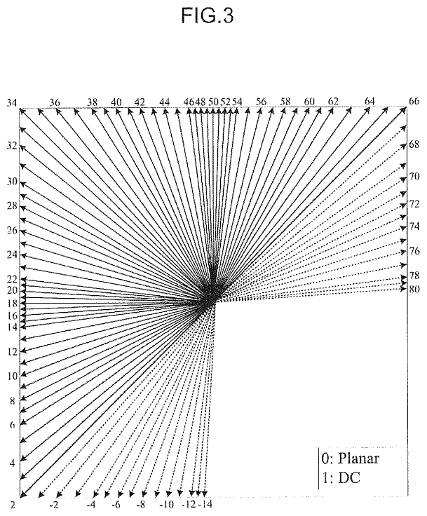

The prediction parameter of the intra prediction is described below. The intra prediction parameter includes a luma intra prediction mode IntraPredMode Y and a chroma intra prediction mode IntraPredModeC. FIG. 3 is a schematic diagram indicating types (mode numbers) of the intra prediction mode. As illustrated in the diagram, for example, there are 67 types (0 to 66) of intra prediction modes. Additionally there are 28 types (−14 to −1 and 67 to 80) of intra prediction modes depend on the aspect ratio of CU. For example, a planar prediction (0), a DC prediction (1), and Angular predictions (2 to 66) are present. Furthermore, for chroma, CCLM (Cross Component Linear Mode1) prediction mode (81 to 83), MMLM (Multi Mode Linear Mode1) prediction mode, and LM (Linear Mode1) prediction modemay be added.

### Configuration of Video Decoding Apparatus

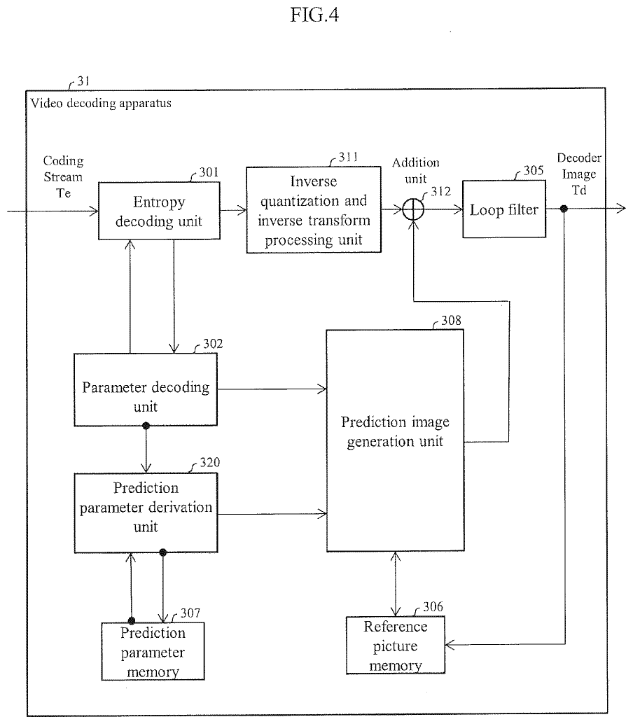

A configuration of the video decoding apparatus 31 (FIG. 4) according to the present embodiment is described.

The video decoding apparatus 31 includes an entropy decoding unit 301, a parameter decoding unit (prediction image decoding apparatus) 302, a loop filter 305, a reference picture memory 306, a prediction parameter memory 307, a prediction image generation unit 308, an inverse quantization and inverse transform processing unit 311, an addition unit 312, and a prediction parameter derivation unit 320. Note that a configuration in which the loop filter 305 is not included in the video decoding apparatus 31 is also used in accordance with the video coding apparatus 11 described later.

The parameter decoding unit 302 further includes a header decoding unit 3020, a CT information decoding unit 3021, and a CU decoding unit 3022 (prediction mode decoding unit), and the CU decoding unit 3022 further includes a TU decoding unit 3024. These may be collectively referred to as a decoding module. The header decoding unit 3020 decodes, from coded data, parameter set information such as the VPS, the SPS, and the PPS, and a slice header (slice information). The CT information decoding unit 3021 decodes a CT from coded data. The CU decoding unit 3022 decodes a CU from coded data. In a case that a TU includes a prediction error, the TU decoding unit 3024 decodes QP update information (quantization correction value) and a quantization prediction error (residual_coding) from coded data.

Furthermore, an example in which a CTU and a CU are used as units of processing is described below, but the processing is not limited to this example, and processing in units of sub-CU may be performed. Alternatively, by replacing the CTU and the CU by a block and replacing the sub-CU by a subblock, and processing in units of blocks or subblocks may be performed.

The entropy decoding unit 301 performs entropy decoding on the coding stream Te input from the outside and separates and decodes individual codes (syntax elements). The separated codes include prediction information to generate a prediction image, a prediction error to generate a difference image, and the like. Entropy coding has a variable length coding method for syntax elements according to the context (probability model) adaptively selected according to the type of syntax elements and the surrounding conditions, and a variable length coding method for syntax elements using a predetermined table or formula.

The parameter decoding unit 302 notifies the entropy decoding unit 301 of which syntax elements need be decoded. The entropy decoding unit 301 outputs the syntax element to the prediction parameter derivation unit 320.

### Configuration of Prediction Parameter Derivation Unit 320

The prediction parameter derivation unit 320 may derive the prediction parameters based on the output of the parameter decoding unit 302 and the prediction parameters which saved in the prediction parameter memory 307. The derived prediction parameters is output into the prediction image generation unit 308 and also is saved in the prediction parameter memory 307. The prediction parameter derivation unit may derive different prediction mode for the Luma and Chroma prediction.

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) on a decoded image of a CU generated by the addition unit 312.

The reference picture memory 306 stores the decoded image of the CU generated by the addition unit 312 in a predetermined position for each target picture and target CU.

The prediction parameter memory 307 stores prediction parameters in a predetermined position for each CTU or CU to be decoded. Specifically, the prediction parameter memory 307 stores a parameter derived by the prediction parameter derivation unit 320, a prediction mode predMode separated by the entropy decoding unit 301, and the like.

The prediction image generation unit 308 receives input of the prediction parameter derived by the prediction parameter deviation unit 320, and the like. In addition, the prediction image generation unit 308 reads a reference picture from the reference picture memory 306. The prediction image generation unit 308 generates a prediction image of a block or a subblock by using the prediction parameter and the read reference picture (reference picture block) in the prediction mode indicated by the prediction mode predMode. Here, the reference picture block refers to a set of pixels (referred to as a block because they are normally rectangular) on a reference picture and is a region that is referred to to generate a prediction image.

### Prediction Image Generation Unit 308

In a case that the prediction mode predMode indicates an intra prediction mode, the intra prediction image generation unit 310 performs an intra prediction by using an intra prediction parameter (luma intra prediction mode IntraPredModeY and/or chroma intra prediction mode IntraPredModeC) input from the prediction parameter derivation unit 320 and reference pixels read from the reference picture memory 306. In a case that the prediction mode predMode indicates an inter prediction mode, the inter prediction image generation unit performs an inter prediction by using an inter prediction parameter input from the prediction parameter derivation unit 320 and reference pixels read from the reference picture memory 306.

Specifically, the prediction image generation unit 308 reads, from the reference picture memory 306, a neighbouring block in a predetermined range from a target block on a target picture. The predetermined range is neighbouring blocks on the left, the top left, the top, and the top right of the target block, and the region referred to is different depending on the intra prediction mode.

The prediction image generation unit 308 generates a prediction image of the target block with reference to the read decoded pixel values and the prediction mode indicated by predMode, IntraPredModeY and/or IntraPredModeC. The prediction image generation unit 308 outputs the generated prediction image of the block to the addition unit 312.

The generation of the prediction image based on the intra prediction mode is described below. In the Planar prediction, the DC prediction, and the Angular prediction, a decoded peripheral region adjacent to (proximate to) the prediction target block is configured as a reference region R. Then, the pixels on the reference region R are extrapolated in a specific direction to generate the prediction image. For example, the reference region R may be configured as an L-shaped region including the left and top (or further, top left, top right, bottom left) of the prediction target block.

### Intra Prediction Image Generation Unit 310

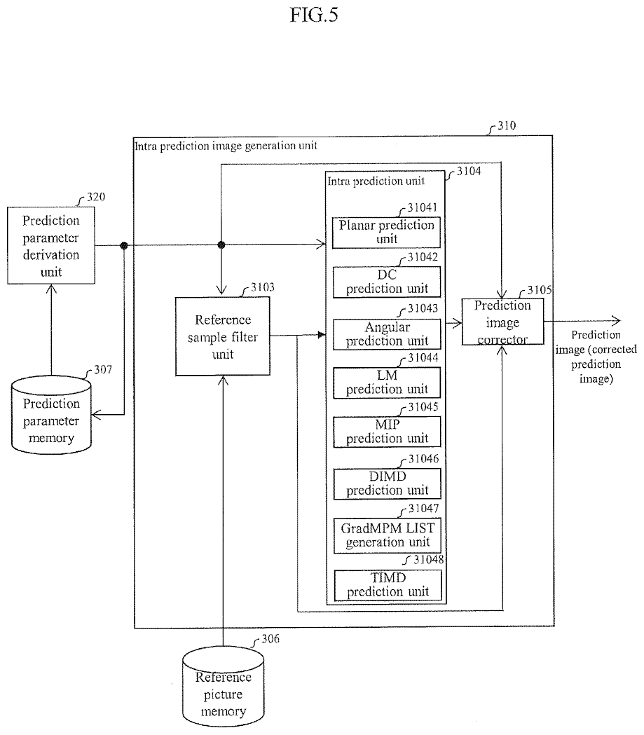

A configuration of the intra prediction image generation unit 310 is described using FIG. 5. The intra prediction image generation unit 310 includes a reference sample filter unit 3103 (second reference image configuration unit), an intra prediction unit 3104), and a prediction image corrector 3105 (prediction image corrector, filter switching unit, weight coefficient changing unit).

Based on each reference pixel (unfiltered reference image) on the reference region R, a filtered reference image generated by applying a reference pixel filter (first filter), and the intra prediction mode, the intra prediction unit 3104 generates a prediction image of the target block, and outputs the generated image to the prediction image corrector 3105. The prediction image corrector 3105 corrects the prediction image in accordance with the intra prediction mode, and outputs a corrected prediction image.

Hereinafter, the units included in the intra prediction image generation unit 310 is described.

### Reference Sample Filter Unit 3103

The reference sample filter unit 3103 applies the reference pixel filter (first filter) to the unfiltered reference image to derive a filtered reference image s[x][y] at each position (x, y) on the reference region R, in accordance with the intra prediction mode. Specifically, a low pass filter is applied to the unfiltered reference image at each position (x, y) and its surroundings, and a filtered reference image is derived. Note that the low pass filter need not necessarily be applied in all the intra prediction modes, and the low pass filter may be applied in some intra prediction modes. Note that the filter applied to an unfiltered reference image on a reference region R in the reference sample filter unit 3103 is referred to as the “reference pixel filter (first filter)”, whereas a filter that corrects the prediction image in the prediction image corrector 3105 described below is referred to as a “boundary filter (second filter)”.

### Configuration of Intra Prediction Unit 3104

The intra prediction unit 3104 generates, based on the intra prediction mode, the unfiltered reference image, and the filtered reference pixel value, a prediction image (prediction pixel value, uncorrected prediction image) of the prediction target block, and outputs a generated image to the prediction image corrector 3105. The intra prediction unit 3104 includes a Planar prediction unit 31041, a DC prediction unit 31042, an Angular prediction unit 31043, an LM prediction unit 31044, an MIP prediction unit (Matrix-based Intra Prediction) 31045, a DIMD (Decoder side Intra Mode Derivation) prediction unit 31046, and a newMPMList generation unit 31047 in the inside thereof. Also the intra prediction unit 3104 may include a TIMD (Template based Intra Mode Derivation) prediction unit 31048, shown in FIG. 5. The intra prediction unit 3104 selects a specific predictor in accordance with the intra prediction mode, and inputs an unfiltered reference image and a filtered reference image thereto.

The relationship between the intra prediction mode and the corresponding predictor is as follows.
Planar prediction . . . Planar prediction unit 31041
DC prediction . . . DC prediction unit 31042
Angular prediction . . . Angular prediction unit 31043
LM prediction . . . LM prediction unit 31044
MIP prediction . . . MIP prediction unit 31045
DIMD prediction . . . DIMD prediction unit 31046
TIMD prediction . . . TIMD prediction unit 31048

### Planar Prediction

The Planar prediction unit 31041 generates a prediction image q[x][y] by linearly adding multiple filtered reference images s[x][y] in accordance with the distance between the prediction pixel position and the reference pixel position, and outputs the generated image to the prediction image corrector 3105.

### DC Prediction

The DC prediction unit 31042 derives a DC prediction value corresponding to the average value of the filtered reference image s[x][y], and outputs a prediction image q[x][y], which takes the DC prediction value as a pixel value.

### Angular Prediction

The Angular prediction unit 31043 generates a prediction image q[x][y] using the filtered reference image s[x][y] in a prediction direction (reference direction) indicated by the intra prediction mode, and outputs the generated image to the prediction image corrector 3105.

### LM Prediction

The LM prediction unit 31044 predicts the pixel value of the chroma based on the pixel value of luma. More specifically, a linear model is used to generate a prediction chroma image (Cb, Cr) based on the decoded luma image. As an example of LM prediction, there is a CCLM (cross component linear model prediction) prediction. CCLM prediction is a prediction method using a linear model to predict chroma from luma to same block.

### MIP Prediction

The MIP prediction unit 31045 generates a prediction image q[x][y] by the product sum operation on the reference sample s[x][y] and the weight matrix derived from the neighboring region, and outputs the prediction image q[x][y] to the prediction image corrector 3105.

### DIMD Prediction

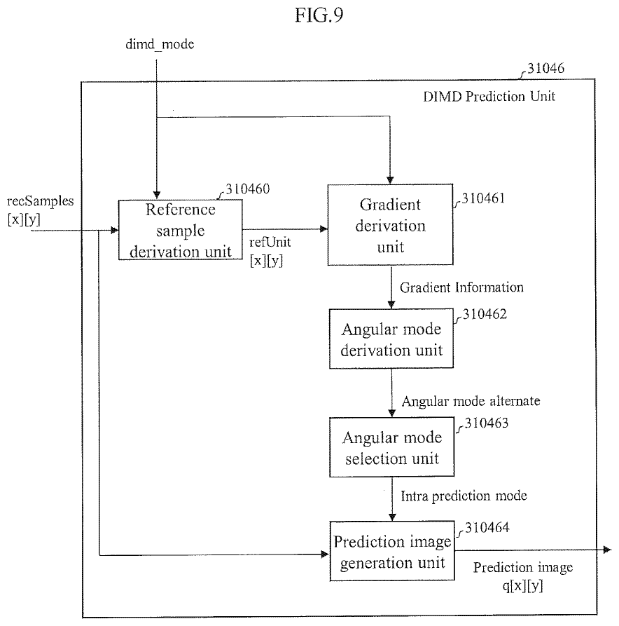

The DIMD prediction unit 31046, shown in FIG. 9, comprises a reference sample derivation unit 310460, a gradient derivation unit 310461, angular mode derivation unit 310462, an angular mode selection unit 310463 and a prediction image generation unit 310464. For each target block, the prediction parameter derivation unit 320 decodes a flag named dimd_flag used for indicating if this target block uses DIMD method.

When dimd_flag is 1, the DIMD prediction unit 31046 derives an angular mode indicating the texture direction in the neighboring region by pixel value. This angular mode can be used to generate an intra prediction image. The reference sample derivation unit 310460 derives reference samples from neibouring samples of the target block. It may be a set of reference mode, indicated by dimd_mode.

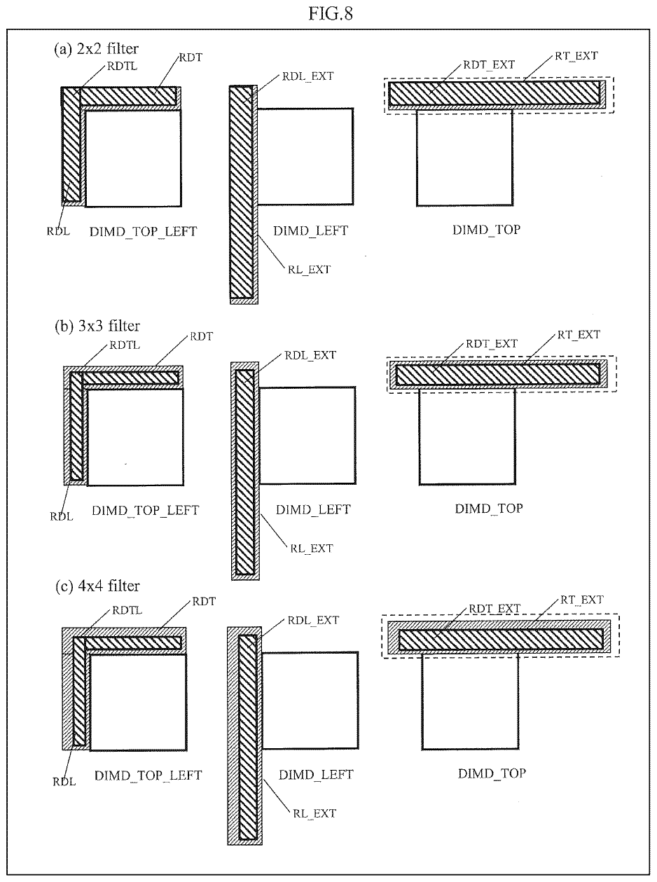

dimd_mode=0 DIMD_MODE_TOP_LEFT (using top neighbouring reference region and left neighbouring reference region, top and left) dimd_mode=1 DIMD_MODE_LEFT (using left neighbouring reference region) dimd_mode=2 DIMD_MODE_TOP (using top neighbouring reference region) FIG. 8 shows an example of the reference range used in the processing of gradient derivation of the dimd prediction. The DIMD prediction unit 31046 may use different filter, e.g. 2×2 filter, 3×3 filter and 4×4 filter for gradient derivation. M×N filter may correspond to filter size, here M is horizontal length and N is vertical size. A variable filterIdx specifies the filter or reference region used for gradient derivation.

FIG. 8(b) show the case where the 3×3 filter (filterIdx==1) is used. When dimd_mode==DIMD_MODE_TOP_LEFT, the angular mode derivation unit 310462 derives Dx and Dy from the each point P of the left region RDL of the target block, derives mode Val and conducts histogram counting operation. Subsequently, Dx and

Dy are derived from each point P of the above region RDT of the target block, and mode Val is derived and histogram counting is conducted.

The area of RDL is x=−refIdxW . . . 2, y=−refIdxH . . . refH-2.

The area of RDT is x=−refIdx W . . . refW-2, y=−refIdxH . . . 2 refIdxW and refIdxH is a constant indicating the width and height of the reference region on the target block. RDTL is an area in which RDL and RDT are combined.

When dimd_mode==DIMD_MODE_LEFT, the angular mode derivation unit 310462 use the extension left region RDL_EXT of the target block, for example, Dx and Dy from the RDL_EXT, for deriving and counting mode Val.

The area of RDL_EXT is x=−refIdxW . . . 2, y=−refledxH . . . refH*2-2.

When dimd_mode==DIMD_MODE_TOP, the angular mode derivation unit 310462 derives mode Val from the extension above region RDT_EXT of the target block, and conducts histogram counting.

The area of RDT_EXT is x=−refIdx W . . . refW*2-2, y=−refIdxH . . . 2 Here, refIdxW=2, refledxH=2, refH=bH (the height of target block), refW=bW (the width of target block).

FIG. 8(b) show the case where the 2×2 filter (filterIdx==0) is used.

In the cases using 2×2 filter:

The area of RDL is x=−refIdx W . . . 2, y=−refledxH . . . refH-2 The area of RDT is x=−refIdxW . . . refW-2, y=−refIdxH . . . 2 RDTL is an area in which RDL and RDT are combined.

The area of RDL_EXT is x=−refIdx W . . . 2, y=−refledxH . . . refH*2-2

The area of RDT_EXT is x=−refIdx W . . . refW*2-2, y=−refIdxH . . . 2 Here, refIdxW=2, refIdxH=2, refH=bH (the height of target block), refW=bW (the width of target block).

FIG. 8(c) show the case where the 2×2 filter (filterIdx==2) is used.

In the cases using 4×4 filter:

The area of RDL is x=−refIdx W . . . 2, y=−refledxH . . . refH-2

The area of RDT is x=−refIdx W . . . refW-2, y=−refIdxH . . . 2 RDTL is an area in which RDL and RDT are combined.

The area of RDL_EXT is x=−refIdxW . . . 2, y=−refledxH . . . refH*2-2 The area of RDT_EXT is x=−refIdx W . . . refW*2-2, y=−refIdxH . . . 2

Here, refIdxW=2, refIdxH=2, refH=bH (the height of target block), refW=bW (the width of target block).

The gradient derivation unit 310461 derives pixel gradient Dx and Dy using the pixel values P[x][y] for a given position (x, y) in the reference samples.

The following formula may used for gradient derivation.

Dx=P[x][y]+P[x][y+1]−P[x+1][y]−P[x+1][y+1]

Dy=P[x][y]+P[x+1][y]−P[x][y+1]−P[x+1][y+1]

Alternatively the following formula may used for gradient derivation.

Dx=P[x−1][y+1]+2*P[x][y+1]+P[x+1][y+1]−P[x−1][y−1]−2*P[x][y−1]−P[x+1][y−1]

Dy=P[x−1][y−1]+2*P[x−1][y]+P[x−1][y+1]−P[x+1][y−1]−2*P[x+1][y]−P[x+1][y+1]

The gradient derivation unit 310461 derives signx, signy, xgty and quadrant as follows.
absx=abs (Dx)
absy=abs (Dy)
signx=Dx<0? 1:0
signy=Dy<0?1:0
xgty=absx>absy?1:0
quadrant=xgty? ((signx\hat{ }signy)?1:0): ((signx\hat{ }signy)?2:3)

Here, unequal sign (>, <) can be replaced by (>=, <=). The angular information can be derived from the signx, signy, and xgty. \hat{ } is an XOR calculation. The quadrant is represented by the value from 0 to 3, {Ra, Rb, Rc, Rd}={0, 1, 2, 3}. The value of the quadrant is not limited to the above.

The angular mode derivation unit 310462 derives iRatio. iRatio=R_UNIT * absy/absx

R_UNIT is the exponential power of 2 (1<<shiftR), e.g. R_UNIT=65536 when shiftR=16. The division may be replaced with “multiplied by its reciprocal”. The reciprocal is derived by a LUT.

e.g. LUT [k]=R_UNIT/k, iRatio=absy * LUT [absx]

The angular mode derivation unit 310462 converts the derived pixel gradient to an angular prediction mode, mode Val by seaching corresponding angular mode corresponding to the iRatio.

```
mode_delta = 16;
for( int i = 1; i < 17; i++ ){
  if( iRatio <= angTable[i] ){
  mode_delta = iRatio − angTable[i − 1] <
  angTable[i] − iRatio ? i − 1 : i;
    break;
  }
}
```

mode Val=base_mode [quadrant]+direction [quadrant] * mode_delta angTable={0, 2048, 4096, 6144, 8192, 12288, 16384, 20480, 24576, 28672, 32768, 36864, 40960, 47104, 53248, 59392, 65536}.

base_mode [4]={18, 18, 50, 50}

direction [4]={−1, 1, −1, 1}

The angular mode derivation unit 310462 counts the number of angular prediction mode mode Val derived from the reference region. It may build a histogram, HistMode [ ] as follows.

### HistMode [Mode Val]+=1

An angular mode selection unit 310463 selects an intra prediction mode with the highest number of occurrence (highest count) as DIMD intra prediction mode or dimdMode, from the histogram. In the following, the selected intra predition are called dimdBestMode (if DIMD_MODE_TOP_LEFT is used), dimdHorMode (if DIMD_MODE_LEFT is used), and dimdVerMode (if DIMD_MODE_VER is used). An angular mode selection unit 310463 may select the second mode with the second highest number as dimdSecondaryMode. Then a prediction image generation unit 310464 may generate a DIMD prediction image using the derived dimdBestMode. DIMD prediction image may be a weighted average of prediction image using dimdBestMode and a prediction image using dimdSecondaryMode.

The DIMD prediction unit 31046 may use plural set of filter and region to derive plural dimdModes. e.g. 2×2 filter with top and left, 4×4 filter with top and left, 3×3 filter with top and 3×3 filter with left.

A video decoding apparatus for generating a prediction image, the video decoding apparatus comprising a DIMD prediction unit configured to derive plural of intra prediction mode using plural set of filter and reference region, and configure to derive a intra prediction image using plural intra prediction images derived by the derived intra prediction modes.

A video decoding apparatus of claim 1, wherein the video decoding apparatus further comprising a DIMD prediction unit configured to derive gradients using a set of filter and reference region, wherein a set consists of 2×2 filter, 3×3 filter or 4×4 filter with top and left neighbouring region, top neighbouring region, or left neighbouring region of the target block.

The DIMD intra prediction mode, dimdMode, derived using the 2×2 filter and 4×4 filter with the DIMD_MODE_TOP_LEFT (top and left), are referred to as dimdMode2×2 and dimdMode4×4, respectively. On the other hand, the frame intra prediction modes with the highest occurrence count, derived using the 3×3 filter with the DIMD_MODE_TOP and DIMD_MODE_LEFT, are referred to as dimdModeTop and dimdModeLeft, respectively.

### GradMPMList Generation

GradMPMList is an intra prediction tool, and it is a list of length NMax that includes the possible prediction modes that can be chosen for the current block. These modes include planar, DC, and angular prediction modes. The GradMPMList may include the prediction methods of neighboring blocks of the current block, as well as 2 or more angular modes derived from the dimd method. When the number of prediction modes mentioned above is less than NMax, the extended modes of these modes can be added to the GradMPMList, within the range of [−4, 4]. If the addition of extended modes still results in fewer than NMax modes in the GradMPMList, default angular prediction modes are to be added to the GradMPMList based on a predefined list. The generation method of the GradMPMList is explained in detail later. NMax is a constant value. It can be 22 but not limited to 22 and other value may be used.

As summary, a video decoding apparatus, wherein the video decoding apparatus further comprising a DIMD prediction unit configured to derive gradients using top left and left and top regions of the target block and derive intra prediction modes as dimdMode2×2, dimdMode4×4, dimdModeTop and dimdModeLeft where dimdMode2×2 is derived based on the 2×2 filter, dimdMode4×4 is derived based on the 4×4 filter, dimdModeTop and dimdModeLeft is derived based on the top region and left region respectly.

### TIMD Prediction

The TIMD prediction unit 31048 derives an intra prediction mode (a template-based intra prediction mode, TIMD intra prediction mode) by template matching and generate a prediction image using the derived intra prediction mode. The TIMD prediction unit 31048 first generates a template image located in the adjacent region (template region). Then, using the image in the reference region (template reference region), the TIMD prediction unit 31048 generates template prediction images for multiple intra prediction mode candidates. Finally, the TIMD prediction unit 31048 selects one or more candidate (TIMD intra prediction modes, timdBestMode, timdSecoundaryMode) with the minimum cost between the template image and the template prediction image. The TIMD prediction unit 31048 generates the intra prediction image using the derived TIMD intra prediction modes. TIMD prediction unit 31048 may select timdHorMode using left neibouring region of the target block and select timdVerMode using top neibouring region of the target block. timdBestMode, timd-SecoundaryMode, timdHorMode, timdVerMode may be referred as timdMode.

Configuration of prediction image corrector 3105 The prediction image corrector 3105 corrects the prediction image output from the intra prediction unit 3104 in accordance with the intra prediction mode. Specifically, the prediction image corrector 3105 derives, by performing weighted addition (weighted-averaging) on the unfiltered reference image and the prediction image for each pixel of the prediction image, in accordance with the distance between the reference region R and the target prediction pixel, the prediction image (corrected prediction image) Pred in which the prediction image is modified. Note that in some intra prediction modes (for example, Planar prediction, DC prediction, or the like), the prediction image corrector 3105 may not correct the prediction image, and the output of the intra prediction unit 3104 may be used as the prediction image.

### Application Examples

### GradMPMList Generation Unit 31047

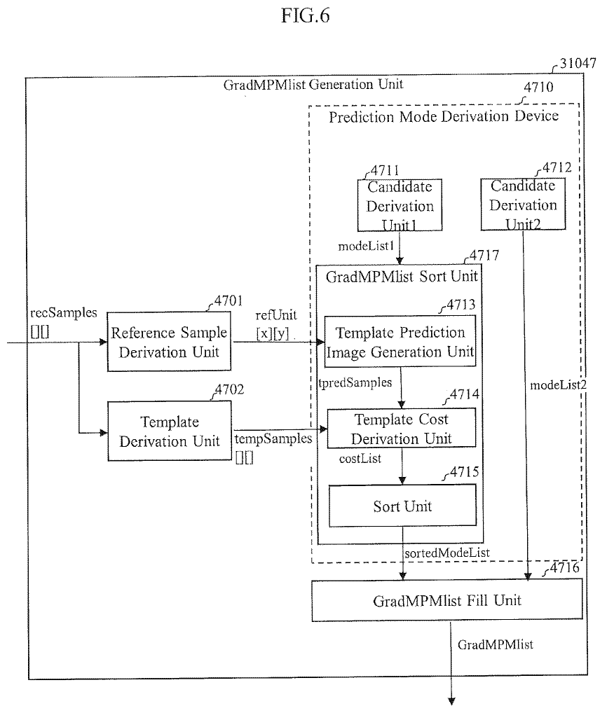

FIG. 6 illustrates the structure of the GradMPMList Generation Unit 31047, which consists of Reference Sample Derivation Unit 4701, Template Derivation Unit 4702, Prediction Mode Derivation Device 4710, and GradMPMList Fill Unit 4716. The Prediction Mode Derivation Device 4710 consists of Candidate Derivation Unit 4711, Candidate Derivation Unit 2 4712. GradMPMList Generation Unit 31047 may further includes GradMPMList Sort Unit 4717. The GradMPMList Sort Unit 4717 comprises Template Prediction Image Generation Unit 4713, Template Cost Derivation Unit 4714, and Sort Unit 4715.

The GradMPMList may generate GradMPMList differently based on the current block's size or shape. As shown in FIG. 6, the GradMPMList may have two generation methods, one are the Generation Route1 with Candidate Derivation Unit 1 4711 and the othwer is the Generation Route2 with Candidate Derivation Unit 2 4712. Their GradMPMList are called modeList1 and mostList2. The choice of route is controlled by a flag selectionFlag. For one example, when the current slice is I_SLICE and the product of the current block's width and height is greater than or equal to sizeTH, the selectionFlag is set to false. sizeTH may equal to 128. For another example, sizeTH is equal to 1024. When the selectionFlag is true, Candidate Derivation Unit 1 4711 and GradMPMList Sort Unit 4717 is used to generate the GradMPMList (modeList1), and when the selectionFlag is false, Candidate Derivation Unit 2 4712 is used to generate the GradMPMList (modeList2).

### Candidate Derivation Unit 4711 and 4712

There are two Candidate Derivation Units, namely, Candidate Derivation Unit 1 4711 and Candidate Derivation Unit 2 4712. In Candidate Derivation Unit 1 4701, the process begins by adding PLANAR_IDX to the Oth position of GradMPMList. Subsequently, based on the intra prediction modes of neighboring blocks, Candidate Derivation Unit 1 4711 appends N prediction modes to the GradMPMList, where N<=numPredMode1. It is noted that the maximum value numPredMode1 is a contant value. numPredMode1 is 7 but not limited to 7, numPredMode1 may be equal to 1, 2, 3, 4, . . . When the number of intra neighboring blocks is equal to or more than numPredMode1, Candidate Derivation Unit 1 4711 outputs an GradMPMList of length numPredMode1+1. Otherwise, Candidate Derivation Unit 1 4711 outputs an GradMPMList of length N+1 (when N<numPredMode1). Candidate Derivation Unit 2 4712 performs the same functions as Candidate Derivation Unit 1 4711, with the difference being that in Candidate Derivation Unit 2 4712, the maximum value numPredMode2 is equal to NMax−1. The GradMPMList generated by Candidate Derivation Unit 2 4712 is sent to GradMPMList Fill Unit 4716 directly, while the GradMPMList produced by Candidate Derivation Unit 1 4711 is sent to GradMPMList Sort Unit 4717.

In addition to the above, in Candidate Derivation Units 4711 and 4712, the results obtained from the DIMD method can also be added to the GradMPMList. DIMD derives 9 prediction modes, namely dimdModefirst, dimdModeSecond, dimd-ModeThird, dimdModeFourth, dimdModeFiveth, dimdMode2×2, dimdMode4×4, dimdModeTop, and dimdModeLeft. A variable called addDimd to specify how many DIMD results is to be added to the GradMPMList. In this case, the range of addDimd is [0, 9]. Additionally, it is noted that the value of numPredaMode1 in Candidate Derivation Unit 4711 can be derived based on the value of addDimd.

### GradMPMList Sort Unit 4717

GradMPMList Sort Unit 4717 performs to sort the elements in the GradMPMList outputted by Candidate Derivation Unit 1 4711 based on SATD cost. It consists of Template Prediction Image Generation Unit 4713, Template Cost Derivation Unit 4714, and Sort Unit 4715.

### Template Prediction Image Generation Unit 4713

Template Prediction Image Generation Unit 4713 generates template prediction images, based on the predicted modes from the GradMPMList. Firstly, it obtains the reference samples required for prediction through the Reference Sample Derivation Unit 4701. Then, for each predicted mode in the GradMPMList, it generates a prediction image. The generated prediction images are collectively referred to as tpredSamples.

### Template Cost Derivation Unit 4714

Template Cost Derivation Unit 4714 calculates the costs of candidate modes using the tempSamples generated by Template Derivation Unit 4702 and the tpredSamples generated by Template Prediction Image Generation Unit 4713. In this unit, costs for all candidate modes are computed for comparison and stored in costList [N+1] array, where the cost calculation is typically based on SATD cost.

### Sort Unit 4715

The Sort Unit 4715 arranges all elements in the current GradMPMList in ascending order of their SATDcost, the SATD costs stored in the costList [ ] obtained from the Template Cost Derivation Unit 4714. The Sort Unit 4715 output the updated GradMPMList (sortedModeList).

### GradMPMList Fill Unit 4716

GradMPMList Fill Unit 4716 filles GradMPMList until the element of the list reaches NMax where GradMPMList is either of modeList1 or modeList2.

GradMPMList Fill Unit 4716 may repeatedly assess the number of elements in the current GradMPMList, danoted, numOfCurrMPM. And if numOfCurrMPM is less than NMax (isFillFull is set equal to false). When isFillFull is false, GradMPMList Fill Unit 4716 fills the current GradMPMList by appending one element. If numOfCurrMPM is equal or larger than NMax (isFillFull is set true), GradMPMList is completed.

The process of appending modes is divided into two steps. The first step involves appending based on the current elements in the GradMPMList, while the second step involves appending based on a predefined list of intra prediction modes.

When adding based on the current elements, all elements in the current GradMPMList are traversed according to the value of numOfCurrMPM. For each element GradMPMList [i] (where i is greater than or equal to 0 and less than numOfCurrMPM), if GradMPMList [i] is an angular prediction mode, extended angular prediction modes around (similar to) GradMPMList [i] are appended to the GradMPMList. The extent of this extension is specified by ExtAngMode. angular prediction modes within a range of plus and minus ExtAngMode relative to GradMPMList [i], are added to the GradMPMList. For example, if ExtAngMode is 4, [GradMPMList [i]−4, GradMPMList [i]−3, GradMPMList [i]−2, GradMPMList [i]−1, GradMPMList [i]+1, GradMPMList [i]+2, GradMPMList [i]+3, GradMPMList [i]+4] are appended. The value of ExtAngMode may be dynamically determined, for instance, based on the value of numOfCurrMPM. Here are two examples of determining ExtAngMode based on the value of numOfCurrMPM:

### Example 1

Smaller values of numOfCurrMPM result in larger values of ExtAngMode. For instance, GradMPMList Fill Unit 4716 applys the follwing.

if numOfCurrMPM<=2, ExtAngMode=6
else if numOfCurrMPM<=4, ExtAngMode=5
else if numOfCurrMPM<=6, ExtAngMode=4
else ExtAngMode=3

For one example, ExtAngMode is set to (NumK-numOfCurrMPM)/DivK. where NumK may be 14 and DivK may be 2.

### Example 2

Smaller values of numOfCurrMPM result in smaller values of ExtAngMode. For instance, GradMPMList Fill Unit 4716 applys the follwing.

if numOfCurrMPM<=2, ExtAngMode=3
else if numOfCurrMPM<=4, ExtAngMode=4
else if numOfCurrMPM<=6, ExtAngMode=5
else ExtAngMode=6

Please note that the above examples are just a few illustrations of how ExtAngMode can be determined based on numOfCurrMPM, and there can be various methods for such determination.

During this addition process, two aspects is to be checked. First, the change in the current number of elements in GradMPMList, and the addition process stops when the element count reaches NMax, concluding the operation of GradMPMList Fill Unit 4716, and derives the GradMPMList. The second aspect to consider is the boundary of angular modes. When the extended angular modes exceed the boundary, they is be re-stricted to the range of angular mode. GradMPMList Fill Unit 4716 may complement with angular modes from the other boundary when the value exceed the boundary. For example, the range of angular mode indices is [2,66], taking GradMPMList [i] as 4, and ExtAngMode also as 4 as an example. In this case, GradMPMList [i]−3 and GradMPMList [i]−4, two extended mode indices, are less than 2. In this situation, GradMPMList [i]−3 is set to 66, and GradMPMList [i]−4 is set to 65. GradMPMList Fill Unit 4716 may (GradMPMList [i]+−k) % 66, k=−ExtAngMode, . . . 1, 1, . . . ExtAngMode.

If, after the aforementioned filling process, the number of elements in the GradMPMList is still less than NMax, it can be filled according to a pre-defined list. This pre-defined list is referred to as the “defaultList” and may consist of NMax−1 elements: [DC_IDX, VER_IDX, HOR_IDX, VER_IDX-4, VER_IDX+4, 14, 22, 42, 58, 10, 26, 38, 62, 6, 30, 34, 66, 2, 48, 52, 16]. During the filling process, each element from the defaultList can be iterated and added to the GradMPMList one by one until the number of elements in the GradMPMList reaches NMax.

GradMPMList Fill Unit 4716 ensures that there are no duplicate elements in the GradMPMList, and that the number of elements in the GradMPMList is exactly NMax. GradMPMList Fill Unit 4716 completes the GradMPMList generation.

The inverse quantization and inverse transform processing unit 311 performs inverse quantization on a quantization transform coefficient input from the prediction parameter derivation unit 320 to calculate a transform coefficient. This quantization transform coefficient is a coefficient obtained by performing a frequency transform such as a Discrete Cosine Transform (DCT), a Discrete Sine Transform (DST), or the like on prediction errors to quantize in coding processing. The inverse quantization and inverse transform processing unit 311 performs an inverse frequency transform such as an inverse DCT, an inverse DST, or the like on the calculated transform coefficient to calculate a prediction error. The inverse quantization and inverse transform processing unit 311 outputs the prediction error to the addition unit 312.

The addition unit 312 adds the prediction image of the block input from the intra prediction image generation unit 310 and the prediction error input from the inverse quantization and inverse transform processing unit 311 for each pixel and generates a decoded image of the block. The addition unit 312 stores the decoded image of the block in the reference picture memory 306 and outputs the image to the loop filter 305.

### Configuration of Video Coding Apparatus

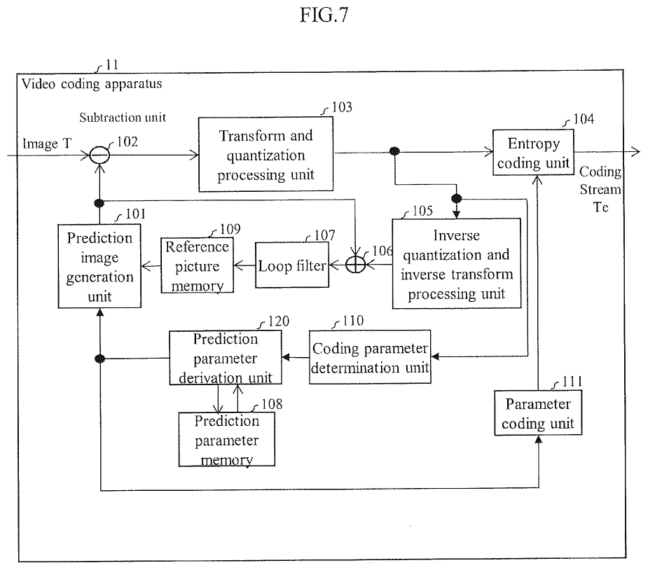

Next, a configuration of the video coding apparatus 11 according to the present embodiment is described. FIG. 7 is a block diagram illustrating a conuration of the video coding apparatus 11 according to the present embodiment. The video coding apparatus 11 is configured to include a prediction image generation unit 101, a subtraction unit 102, a transform and quantization processing unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coding unit 111, prediction parameter derivation unit 120, and an entropy coding unit 104.

The prediction image generation unit 101 generates a prediction image for each CU that is a region obtained by splitting each picture of the image T. The operation of the prediction image generation unit 101 is the same as that of the intra prediction image generation unit 310 already described, and thus descriptions thereof is omitted.

The subtraction unit 102 subtracts a pixel value of the prediction image of the block input from the prediction image generation unit 101 from a pixel value of the image T to generate a prediction error. The subtraction unit 102 outputs the prediction error to the transform and quantization processing unit 103.

The transform and quantization processing unit 103 calculates a transform coefficient by performing a frequency transform on the prediction error input from the subtraction unit 102, and derives a quantization transform coefficient by quantization. The transform and quantization proceessing unit 103 outputs the quantization transform coefficient to the entropy coding unit 104 and the inverse quantization and inverse transform processing unit 105.

The inverse quantization and inverse transform processing unit 105 is the same as the inverse quantization and inverse transform processing unit 311 (FIG. 4) in the video decoding apparatus 31, and descriptions thereof are omitted. The calculated prediction error is output to the addition unit 106.

To the entropy coding unit 104, the quantization transform coefficient is input from the transform and quantization processing unit 103, and coding parameters are input from the parameter coding unit 111. The entropy coding unit 104 performs entropy coding on split information, the prediction parameters, the quantization transform coefficient, and the like to generate and output the coding stream Te.

The parameter coding unit 111 instructs the entropy coding unit 104 to encode the prediction parameters and quantization coefficients, derived from the prediction parameter derivation unit 120.

The prediction parameter derivation unit 120 derives the syntax element from the parameters inputted from the coding parameter determination unit 110. Some parts of the prediction parameter derivation unit 120 have the same structure as the prediction parameter derivation unit 320.

The addition unit 106 adds a pixel value of the prediction image of the block input from the prediction image generation unit 101 and the prediction error input from the inverse quantization and inverse transform processing unit 105 to each other for each pixel, and generates a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the prediction parameter derivation unit 120 for each target picture and CU at a predetermined position. It may stores the transform coefficients created by the transform and quantization processing unit 103.

The reference picture memory 109 stores the decoded image generated by the loop filter 107 for each target picture and CU at a predetermined position.

The coding parameter determination unit 110 selects one set among multiple sets of coding parameters. A coding parameter refers to the above-mentioned QT, BT, or TT split information, the prediction parameter, or a parameter to be coded, the parameter being generated in association therewith. The prediction image generation unit 101 generates the prediction image by using these coding parameters.

The coding parameter determination unit 110 calculates, for each of the multiple sets, an RD cost value indicating the magnitude of an amount of information and a coding error. The RD cost value is, for example, the sum of a code amount and the value obtained by multiplying a coefficient à by a square error. The coding parameter determination unit 110 selects a set of coding parameters of which cost value calculated is a minimum value. With this configuration, the entropy coding unit 104 outputs the selected set of coding parameters as the coding stream Te. The coding parameter determination unit 110 outputs the determined coding parameters in the parameter coding unit 111, the prediction parameter derivation unit 120, the prediction image generation unit 101.

Note that, some of the video coding apparatus 11 and the video decoding apparatus 31 in the above-described embodiment, for example, the entropy decoding unit 301, the parameter decoding unit 302, the loop filter 305, the intra prediction image generation unit 310, the inverse quantization and inverse transform processing unit 311, the addition unit 312, the prediction parameter derivation unit 320, the prediction image generation unit 101, the subtraction unit 102, the transform and quantization processing unit 103, the entropy coding unit 104, the inverse quantization and inverse transform processing unit 105, the loop filter 107, the coding parameter determination unit 110, and the parameter coding unit 111, the prediction parameter derivation unit 120, may be realized by a computer. In that case, this configuration may be realized by recording a program for realizing such control functions on a computer-readable recording medium and causing a computer system to read the program recorded on the recording medium for execution. Note that the “computer system” mentioned here refers to a computer system built into either the video coding apparatus 11 or the video decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Furthermore, a part or all of the video coding apparatus 11 and the video decoding apparatus 31 in the embodiment described above may be realized as an integrated circuit such as a Large Scale Integration (LSI). Each function block of the video coding apparatus 11 and the video decoding apparatus 31 may be individually realized as processors, or part or all may be integrated into processors. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

The embodiment of the present disclosure has been described in detail above referring to the drawings, but the specific configuration is not limited to the above embodiments and various amendments may be made to a design that fall within the scope that does not depart from the gist of the present disclosure.

The embodiment of the present invention may be applied to a video decoding device that decodes encoded data of image data, and a video encoding device that generates encoded data from image data. In addition, the data structure of the encoded data is generated by the video encoding device and referenced by the video decoding device.

### REFERENCE SIGNS LIST

31 Image decoding apparatus
301 Entropy decoding unit
302 Parameter decoding unit
310 Prediction image generation unit
3104 Intra prediction unit
31046 DIMD prediction unit
310460 Reference sample derivation unit
310461 Gradient derivation unit
310462 Angular mode derivation unit
310463 Angular mode selection unit
310464 Prediction image generation unit
31047 GradMPMList generation unit
4701 Reference sample derivation unit
4702 Template derivation unit
4710 Prediction Mode Derivation Device
4711 Candidate derivation unit1
4712 Candidate derivation unit2
4717 GradMPMList Sort unit
4713 Template prediction image generation unit
4714 Template cost derivation unit
4715 Sort unit
4716 GradMPMList fill unit
31048 TIMD prediction unit
311 Inverse quantization and inverse transform processing unit
312 Addition unit
11 Image coding apparatus
101 Prediction image generation unit
102 Subtraction unit
103 Transform and quantization processing unit
104 Entropy coding unit
105 Inverse quantization and inverse transform processing unit
107 Loop filter
110 Coding parameter determination unit
111 Parameter coding unit

1. A video decoding apparatus for generating a prediction image, the video decoding apparatus comprising a DIMD prediction unit configured to derive plural of intra prediction mode using plural set of filter and reference region, and configure to derive a intra prediction image using plural intra prediction images derived by the derived intra prediction modes.

2. A video decoding apparatus of claim 1, wherein the video decoding apparatus further comprising a DIMD prediction unit configured to derive gradients using a set of filter and reference region, wherein a set consists of 2×2 filter, 3×3 filter or 4×4 filter with top and left neighbouring region, top neighbouring region, or left neighbouring region of the target block.

3. A video decoding apparatus of claim 2, wherein the video decoding apparatus further comprising a DIMD prediction unit configured to derive gradients using top left and left and top regions of the target block and derive intra prediction modes as dimdMode2×2,
dimdMode4×4, dimdModeTop and dimdModeLeft where dimdMode2×2 is derived based on the 2×2 filter, dimdMode4×4 is derived based on the 4×4 filter, dimdModeTop and dimdModeLeft is derived based on the top region and left region respectly.

4. A video decoding apparatus of claim 2, wherein the video decoding apparatus further comprising a DIMD prediction unit configured to derive gradients using top left regions of the target block and derive intra prediction modes of dimdModeFirst, dimdModeSecond, dimd-ModeThird, dimdModeFourth, and dimdModeFiveth.

5. A video decoding apparatus of claim 1, wherein the video decoding apparatus further comprising a GradMPMList generation unit configured to derive GradMPMList using a dynamically extention range E.

6. A video coding apparatus comprising an MPM candidate generation unit configured to derive a MPM candidate list of intra prediction modes.
